(19) United States
(12) Patent Application Publication
(10) Pub. No.: US 2015/0023189 A1
(43) Pub. Date: Jan. 22, 2015

(54) PACKET ANALYSIS DEVICE AND PACKET ANALYZING METHOD

(71) Applicant: FUJITSU LIMITED, Kawasaki-shi (JP)

(72) Inventors: SUMIYO OKADA, Kawasaki (JP); Yuji NOMURA, Kawasaki (JP)

(21) Appl. No.: 14/328,038

(22) Filed: Jul. 10, 2014

(30) Foreign Application Priority Data
Jul. 19, 2013 (JP) 2013-150926

(51) Int. Cl. H04W 24/08

(52) U.S. Cl. CPC H04W 24/08
USPC 370/252

(57) ABSTRACT

A packet analysis device includes a processor that executes a process including receiving a packet to be transmitted to a terminal device through a relay device, calculating a delay time indicating time taken by the relay device from start to completion of the transmission of the packet according to the received packet, and analyzing communication quality between the relay device and the terminal device when a reception interval of the packet is longer than the delay time.

### CROSS-REFERENCE TO RELATED APPLICATIONS

This application is based upon and claims the benefit of priority of the prior Japanese Patent Application No. 2013-150926, filed on Jul. 19, 2013 the entire contents of which are incorporated herein by reference.

### FIELD

The embodiments described herein are related to the analysis of a packet communicated in a communication network.

### BACKGROUND

Recently, a bidirectional communication over a packet communication network has been actively performed with the development of information technology. For example, a piece of packetized data may be communicated over a packet communication network by the TCP/IP (transmission control protocol/Internet protocol) which has been widely recognized as a standard protocol of the Internet. In the packet communication network, it is important to monitor and manage communication quality. To monitor and manage communication quality over the packet communication network, a monitor device may be installed in the packet communication network. The monitor device is a packet analysis device which may receive a packet which passes through a relay device (for example, a branch device such as a switch, a tap, etc.) in the packet communication network, and monitor the communication quality of the packet communication network.

There is a monitor device which analyzes the communication quality of a packet communication network using a reception interval of a packet.

Japanese Laid-open Patent Publication No. 2005-252608

### SUMMARY

According to an aspect of the embodiment, a packet analysis device includes a processor that executes a process including receiving a packet to be transmitted to a terminal device through a relay device, calculating a delay time indicating time taken by the relay device from start to completion of the transmission of the packet according to the received packet, and analyzing communication quality between the relay device and the terminal device when a reception interval of the packet is longer than the delay time.

The object and advantages of the invention will be realized and attained by means of the elements and combinations particularly pointed out in the claims.

It is to be understood that both the foregoing general description and the following detailed description are exemplary and explanatory and are restrictive of the invention.

### BRIEF DESCRIPTION OF DRAWINGS

FIG. 1 is a block diagram of the function by illustrating the configuration of an embodiment of the packet analysis device;

FIG. 2 is an example of a configuration of the communication system according to an embodiment of the present invention;

FIG. 3 is an explanatory view of an analyzing process for judging the type of a wireless section in a monitor device;

FIGS. 4A and 4B are explanatory views of a serialization delay;

FIG. 5 is an example of the flow of a packet between a wired terminal and a wireless terminal when it is assumed that no serialization delay occurs;

FIG. 6 is an example of the flow of a packet between a wired terminal and a wireless terminal when it is assumed that a serialization delay occurs;

FIG. 7 is an example of the case in which there is no influence of a serialization delay in judging the type of wireless section;

FIG. 8 is an example of the case in which there is an influence of a serialization delay in judging the type of wireless section;

FIG. 9 is an example of a flow of a packet from a wired terminal to a wireless terminal when there is no influence of a serialization delay;

FIG. 10 is an example of a flow of a packet from a wired terminal to a wireless terminal when there is an influence of a serialization delay;

FIG. 11 is an example of a configuration of the function of the communication program of the monitor device;

FIG. 12 is an example of a configuration of the header of an Ethernet frame;

FIG. 13 is an example of a configuration of an IP header;

FIG. 14 is an example of a configuration of a TCP header;

FIG. 15 is an example of reception history information recorded by a record unit;

FIG. 16 is a flowchart of the process as an example of a method of calculating a serialization delay;

FIG. 17 is an example of the wireless retransmission period information in which the value of the wireless retransmission period is recorded for each type;

FIG. 18 is a flowchart of the process of the monitor device when the device receives a packet;

FIG. 19 is a flowchart of the process as an example of the wireless section type judging process by the monitor device;

FIGS. 20A and 20B are explanatory views of the method of calculating a serialization delay by measuring the RTT when the sizes of packets are the same;

FIG. 21 is a flowchart of the method of calculating a serialization delay by measuring the RTT when the sizes of packets are the same;

FIGS. 22A and 22B are explanatory views of the method of calculating a serialization delay when the sizes of packets are not the same;

FIG. 23 is a flowchart of the method of calculating a serialization delay when the sizes of packets are not the same; and

FIG. 24 is an example of a configuration of the hardware of the monitor device.

### DESCRIPTION OF EMBODIMENTS

The packet communication network may include a wired section (for example, a wired line) and a wireless section (for example, a wireless line), and a wireless communication device may be used as a terminal of the packet communication network. A relay device which relays a packet between a wired section and a wireless section in a packet communication network transmits a packet received from wired network to wireless network. In this case, the relay device may incur a delay from the start to the completion of the transmission of a packet depending on the packet size or the bandwidth. If the influence of a transmission delay is large, the influence of the transmission delay on the result of the analysis of the communication quality in the monitor device becomes large, and the ratio of the information to be originally analyzed becomes small, thereby relatively increasing the influence of the margin of error included therein. Therefore, there is the possibility that the analysis accuracy of the communication quality by the monitor device is degraded.

The monitor device according to an embodiment of the present invention may suppress the degradation of the analysis accuracy of the communication quality by the delay caused from the start to the completion of the transmission of a packet in the relay device.

The monitor device analyzes the communication quality using the reception interval of two received packets. For example, the monitor device calculates (estimates) the retransmission time when a retransmission occurs by the relay device which relays a packet using the reception interval of the two received packets and the reception interval of an acknowledge packet of the received packets. Then, the monitor device judges the type of a wireless section by comparing the calculated retransmission time with the retransmission time specified in advance for each type of wireless section. However, there is the possibility that the monitor device is unable to accurately calculate the retransmission time to be calculated (estimated) based on the reception interval of a packet due to the delay caused in the relay device from the start to the completion of the transmission of a packet. In this case, the judgment accuracy of the type of wireless section is degraded. The monitor device judges the case in which the retransmission time is not accurately calculated, and does not judge the type of wireless section. Thus suppressed is the degradation of the analysis accuracy of the communication quality by the delay caused from the start to the completion of the transmission of a packet in the relay device.

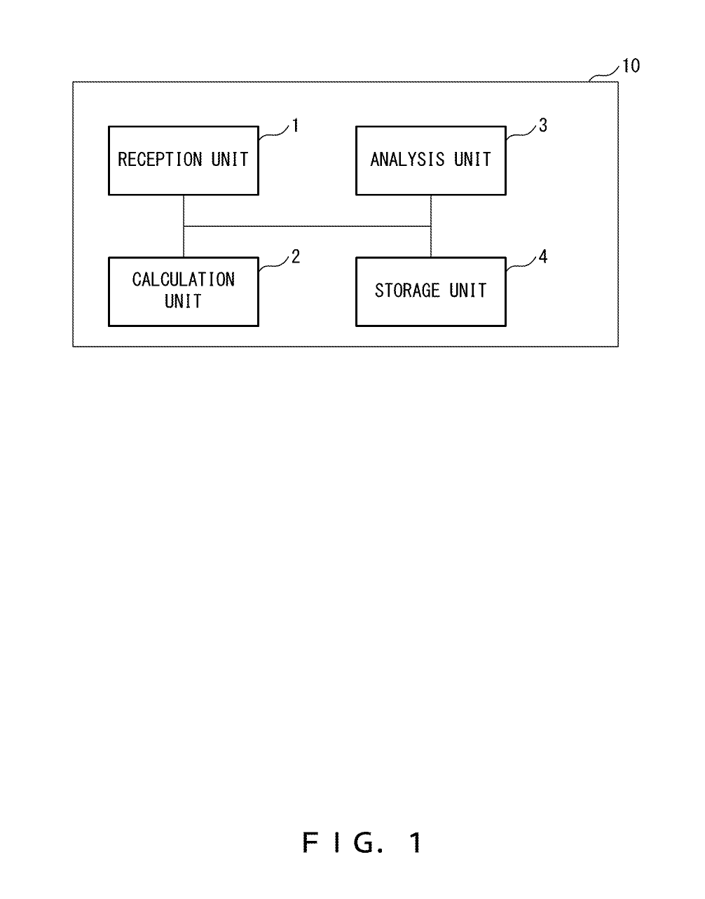

FIG. 1 is a block diagram of the function by illustrating the configuration of an embodiment of the packet analysis device. In FIG. 1, a packet analysis device 10 includes a reception unit 1, a calculation unit 2, an analysis unit 3, and a storage unit 4.

The reception unit 1 receives a packet to be transmitted to a terminal device through a relay device. The reception unit also receives an acknowledge packet for the packet.

Based on the received packet, the calculation unit 2 calculates the delay time indicating the time taken by the relay device from the start to the completion of the transmission of a packet. In addition, based on the packet received from the wired section, the calculation unit calculates the delay time taken by the relay device from the start to the completion of the transmission of a packet to a wireless section. Furthermore, using the difference between the reception interval of the first and second packets and the reception interval of the acknowledge packet for the first packet and the acknowledge packet for the second packet, the calculation unit calculates the delay time taken by the relay device from the start to the completion of the transmission of a packet to the wireless section.

The analysis unit 3 analyzes the communication quality between the relay device and the terminal device when the reception interval of packets is longer than the delay time.

The storage unit 4 stores the transmission rate information about the wireless section. Based on the transmission rate information about the wireless section stored in the storage unit 4 and the size of the packet received from the wired section, the calculation unit 2 calculates the delay time taken by the relay device from the start to the completion of the transmission of a packet to the wireless section.

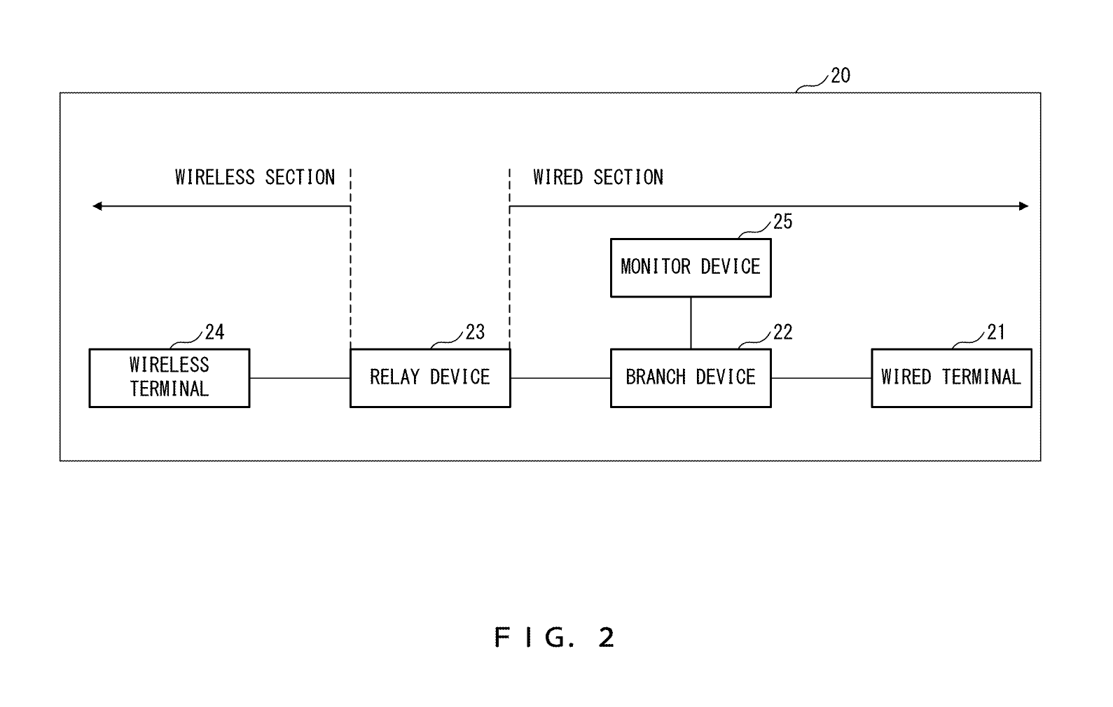

FIG. 2 is an example of a configuration of a communication system 20 according to the present embodiment.

The communication system 20 includes a wired terminal 21, a branch device 22, a relay device 23, a wireless terminal 24, and a monitor device 25. The wired terminal 21 is connected to the relay device 23 through a wired section, and the branch device 22 is arranged on the wired path of the wired terminal 21 and the relay device 23. The branch device 22 connects the wired terminal 21 to the relay device 23, and also connects the monitor device 25. The relay device 23 is connected to the wireless terminal 24 through a wireless section. In the present embodiment, it is assumed that the transmission rate of the wired section (the line in the wired section) is higher than that of the wireless section (the line in the wireless section). The monitor device 25 is an example of the packet analysis device 10.

The wired terminal 21 transmits a packet to the wireless terminal 24. Then, the wired terminal 21 receives an acknowledge packet for the transmitted packet from the wireless terminal 24. In the following description, the packet transmitted from the wired terminal 21 to the wireless terminal 24 is described as a data packet, and the acknowledge packet transmitted from the wireless terminal 24 to the wired terminal 21 in response to the data packet is described as an ACK packet. A packet communicated between the wired terminal 21 and the wireless terminal 24 is, for example, a TCP packet. When a packet is received by a destination terminal, the destination terminal returns the information about the arrival of the packet.

The branch device 22 captures a data packet and an ACK packet which is transmitted over the wired path. Then, the branch device 22 forwards the captured packet to the destination of the packet, replicates the captured packet, and transfers the packet to the monitor device 25. The branch device 22 is, for example, a tap, a repeater hub, a switch, etc. For example, a mirror port of a switch may be connected to the monitor device 25, and the packet may be transferred from the mirror port to the monitor device 25.

The relay device 23 receives a data packet from a wired section, converts the received data packet into a wireless communication format, and transmits the converted packet to the wireless terminal 24 through a wireless section. The relay device 23 also receives an ACK packet from the wireless section, converts the received ACK packet into a wired communication format, and transmits the converted packet to the wired terminal 21. The relay device 23 is, for example, a base station of a mobile telephone.

The wireless terminal 24 receives the data packet from the wired terminal 21. Then, the wireless terminal 24 returns to the wired terminal 21 an ACK packet about the reception of the data packet.

The monitor device 25 analyzes various information about a wireless section based on the data packet transmitted from the wired terminal 21 to the wireless terminal 24 and the ACK packet as an acknowledge packet in response to the data packet. An example of the analysis of the information is concretely an analyzing process for judgment of the type of the wireless section. When a wireless type judgment is performed, the quality (good or bad) of each wireless type maybe judged, and the occurrence of the problem in a wireless section may be located. The monitor device 25 maybe arranged in a wired section, not in a wireless section, to easily capture a packet. Furthermore, by arranging the monitor device 25 not near a wireless terminal, but in a wired section as a core network, the aggregation of the monitor device 25 may be performed, thereby decreasing the number of the monitor devices 25.

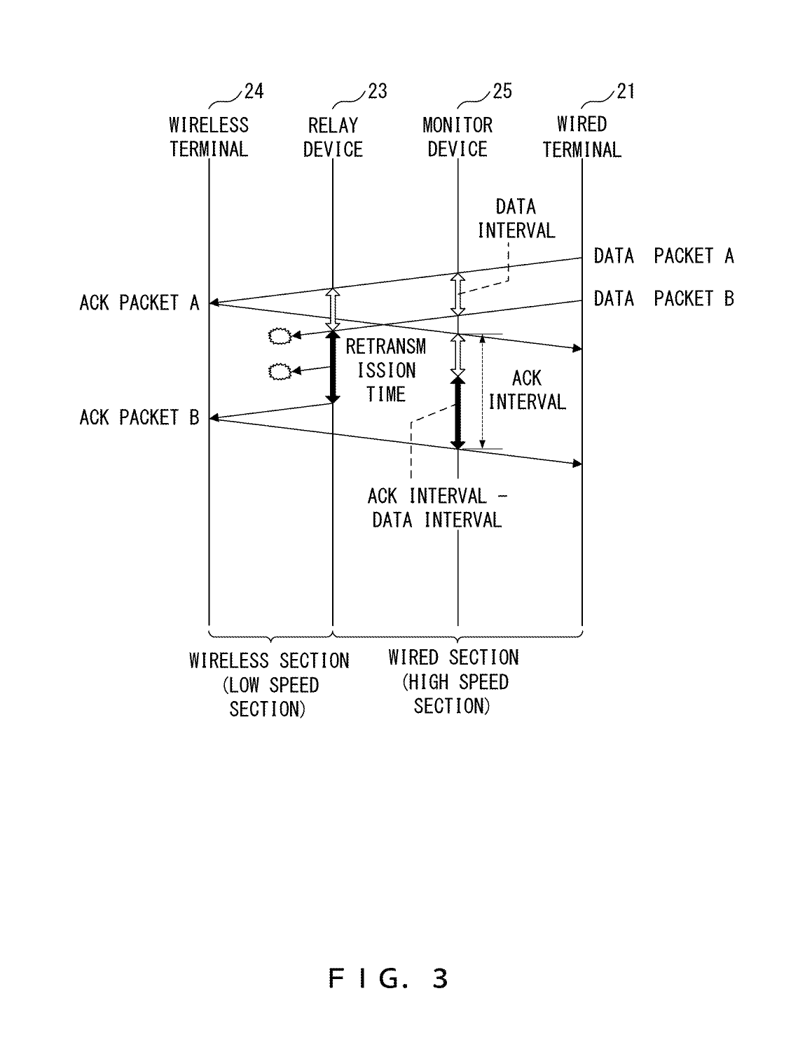

FIG. 3 is an explanatory view of an analyzing process for judging the type of a wireless section in the monitor device 25. Using the reception time of the received packet, the monitor device 25 calculates (estimates) the retransmission time when the retransmission occurs by the relay device 23, and compares the calculated retransmission time with the retransmission time specified for each type of wireless section, thereby judging the type of the wireless section.

Concretely, upon receipt of the data packet from the wired terminal 21, the monitor device 25 records the reception time of the received data packet at the monitor device 25. Upon receipt of the ACK packet corresponds to the data packet of which reception time is recorded, the monitor device 25 records the reception time of the received ACK packet at the monitor device 25. Then, the monitor device 25 regards two data packets (in this example, they are referred to as data packets A and B, and it is assumed that the data packet A has been received before the data packet B) in the data packets whose retransmission time has been recorded, and the difference in reception time between the two data packets is calculated. The difference in reception time between the data packets A and B is referred to as a data interval in the following description. The monitor device 25 acquires the difference in reception time between the ACK packets A and B respectively corresponding to the regarded data packets A and B. The difference in reception time between the ACK packets A and B is hereafter referred to as an ACK interval. Then, the monitor device 25 calculates (estimates) the time (retransmission time) taken to retransmit the packet by the relay device 23 by obtaining the difference in data interval from the ACK interval at the monitor device 25. Then, the monitor device 25 judges the type of wireless section by comparing the difference between the ACK interval and the data interval with the retransmission time taken for each type of wireless section (line) stored in advance in a specified storage area of the monitor device 25. Thus, the monitor device 25 may judge the type of wireless section by storing the reception time of the captured packet, calculating the difference between the data interval and the ACK interval, and comparing it with the retransmission time of each wireless section (line).

In the relay device 23, the data packet received from a high-speed wired section is transmitted to a low-speed wireless section. In this case, the relay device 23 takes some time to convert a packet which is to be transmitted through an interface into a physical signal such as an electric signal, an optical signal, radio waves, etc. and a delay occurs when the data packet received from the wired section to the wireless section. The delay is referred to as a serialization delay.

The serialization delay of data to be transmitted to the wireless section is obtained by the following equation (1).

serialization delay=size of data to be transmitted to wireless section/transmission rate of wireless section (1)

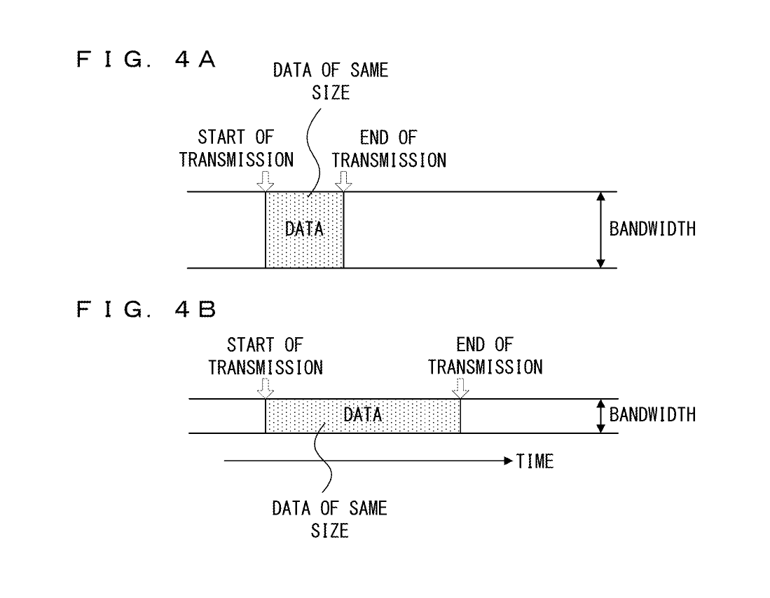

FIGS. 4A and 4B are explanatory views of a serialization delay. FIG. 4A illustrates a line having a large bandwidth, and FIG. 4B illustrates a line having a small bandwidth. Although the data of the same size is transmitted, it takes a shorter time to transmit the data through the line having the large bandwidth from the start to the completion of the transmission of a packet while it takes a longer time to transmit the data through the line having the small bandwidth from the start to the completion of the transmission of a packet.

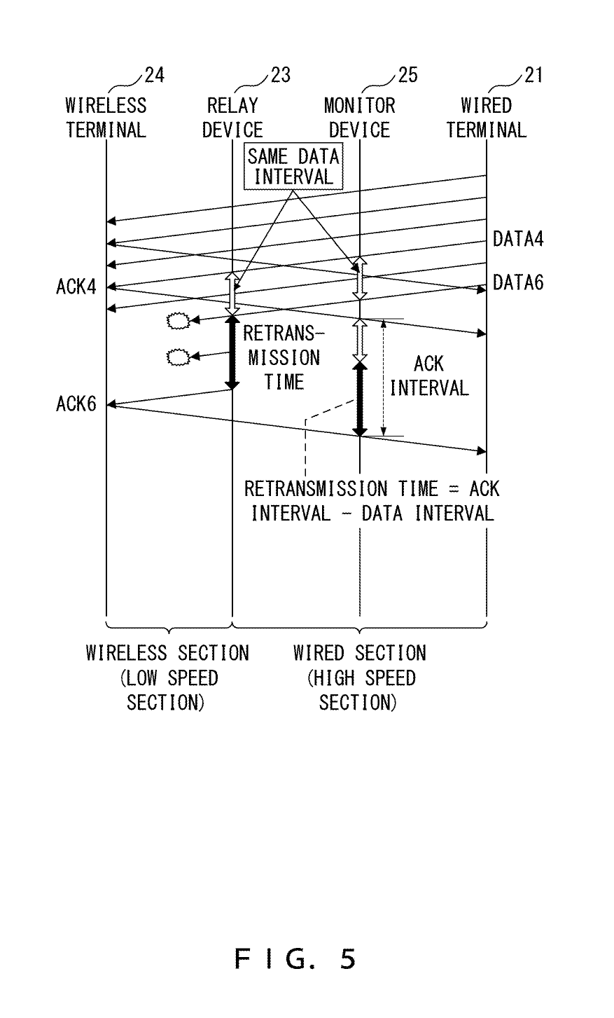

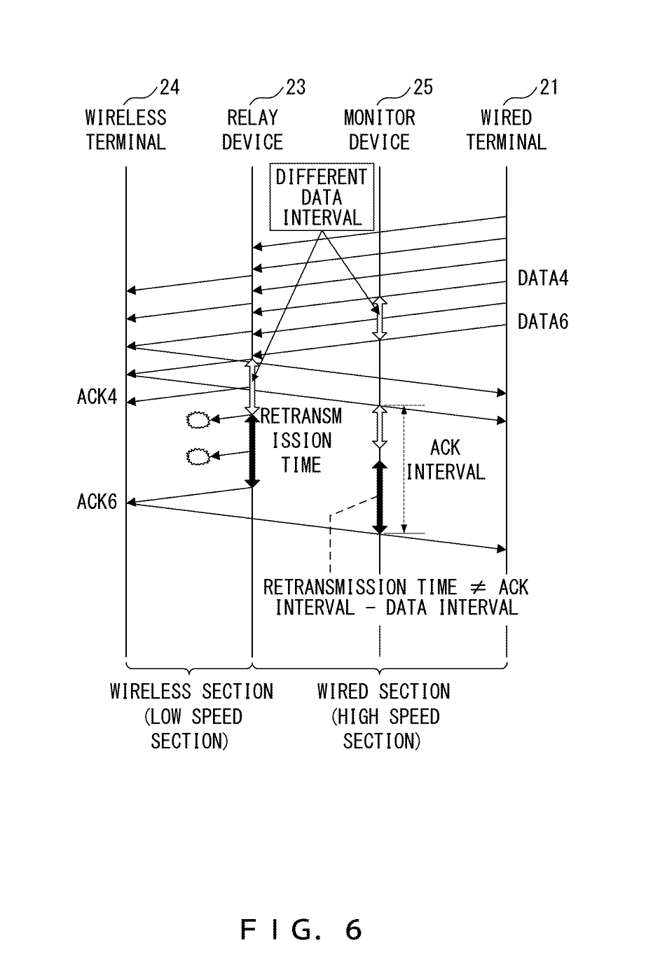

When the serialization delay occurs in the relay device 23, the accuracy of the judgment of the type of wireless section explained above with reference to FIG. 3 is degraded. In the process of judging the type of wireless section in FIG. 3, the time taken to retransmit data by the relay device 23 is calculated by obtaining a difference between the ACK interval and the data interval at the monitor device 25. However, when a serialization delay occurs, the difference between the ACK interval and the data interval is shifted from the time taken to perform the practical retransmission, which is described below with reference to FIGS. 5 and 6.

FIG. 5 is an example of the flow of a packet between the wired terminal 21 and the wireless terminal 24 when it is assumed that no serialization delay occurs. FIG. 6 is an example of the flow of a packet between the wired terminal 21 and the wireless terminal 24 when it is assumed that a serialization delay occurs.

In the example in FIG. 5, since it is assumed that there is no serialization delay in the relay device 23, the data interval in the wired section is equal to the data interval in the wireless section when no retransmission occurs in the wireless section. Therefore, the difference between the ACK interval and the data interval at the monitor device 25 is equal to the retransmission.

On the other hand, in the example illustrated in FIG. 6, the data interval in the wired section is different from the data interval in the wireless section although no retransmission occurs in the wireless section. It is because the data interval in the wireless section is longer than the data interval in the wired section since it is assumed that there occurs a serialization delay in the relay device 23. In this case, the difference between the ACK interval and the data interval at the monitor device 25 is not equal to the retransmission time.

In the judgment of the type of wireless section explained above with reference to FIG. 3, the type of wireless section is judged by comparing the difference between the ACK interval and the data interval with the retransmission time taken for each section (line) stored in the specified storage area of the monitor device 25. In the judgment, the type of a wireless section is not accurately judged when the difference between the ACK interval and the data interval is shifted from the retransmission time by the influence of the serialization delay as illustrated in FIG. 6.

Then, according to the present embodiment, when there is an influence of a serialization delay on the result of the judgment of the type of wireless section, the monitor device 25 does not judge the type of wireless section, thereby suppressing the degradation of the accuracy of the judgment of the type of wireless section.

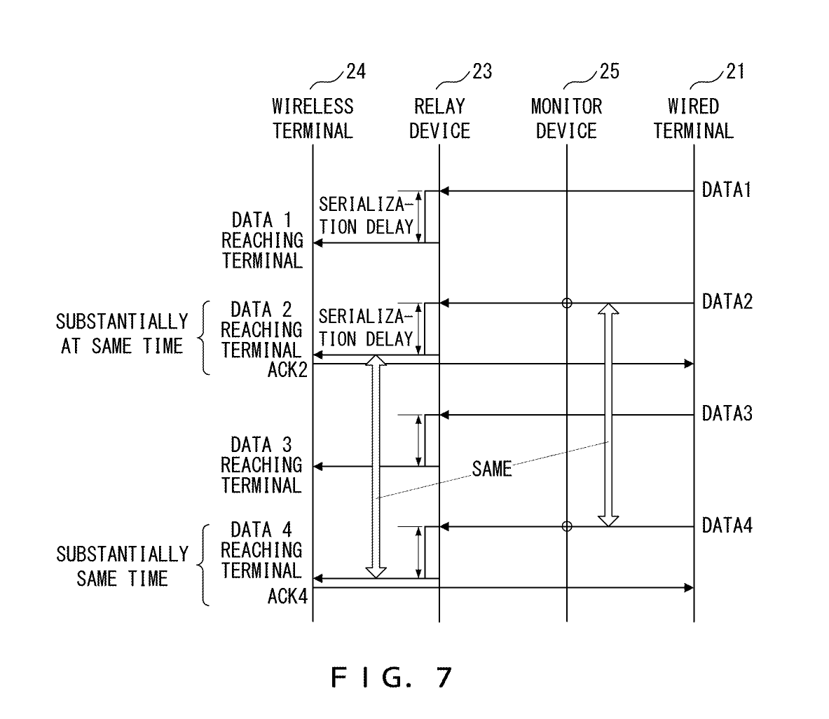

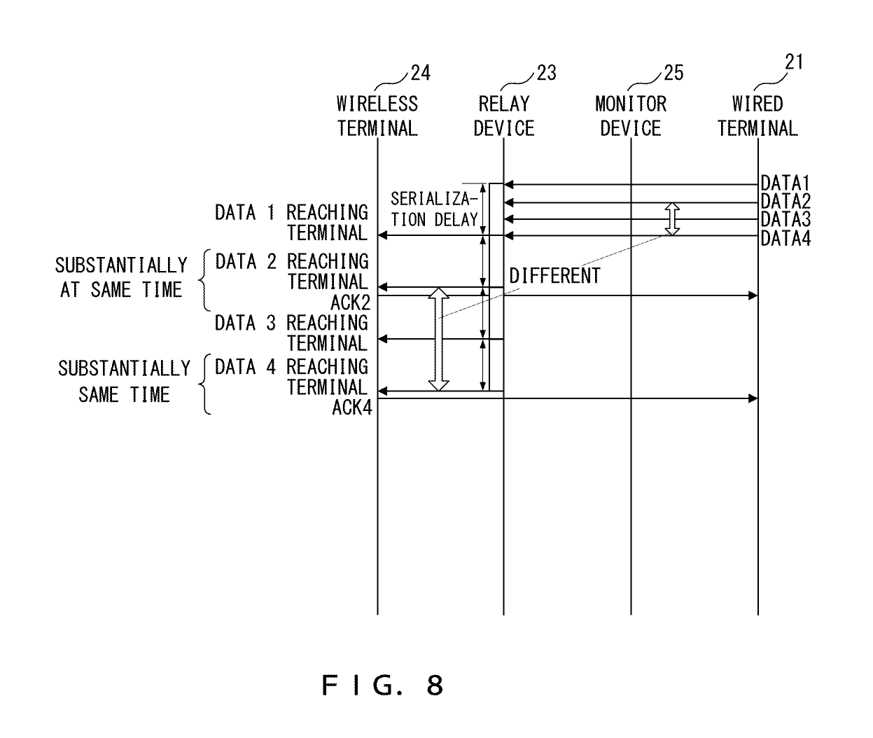

Described next in detail is the case in which there is an influence of the serialization delay on the result of the judgment on the type of wireless section. As explained below with reference to FIGS. 7 and 8, there are the cases in which there is, and is not an influence of a result of the judgment on the type of wireless section.

FIG. 7 is an example of the case in which there is no influence of a serialization delay in judging the type of wireless section. When there is no influence of a serialization delay, the data interval at the monitor device 25 is not less than the value of the serialization delay. As illustrated in FIG. 7, when the data interval at the monitor device 25 is not less than the value of the serialization delay, the data interval in the wired section is equal to the data interval in the wireless section. Therefore, as explained above with reference to FIG. 5, since the difference between the ACK interval and the data interval at the monitor device 25 is equal to the retransmission time, there is no influence on the result of the judgment on the type of wireless section.

FIG. 8 is an example of the case in which there is an influence of a serialization delay in judging the type of wireless section. When there is an influence of a serialization delay, the data interval at the monitor device 25 is smaller than the value of the serialization delay. In this case, the data interval in the wired section is different from the data interval in the wireless section. Therefore, as explained with reference to FIG. 6, since the difference between the ACK interval and the data interval at the monitor device 25 is not equal to the retransmission time, there occurs an influence on the result of the judgment on the type of wireless section. Therefore, when the data interval at the monitor device 25 is smaller than the value of the serialization delay, the monitor device 25 does not judge the type of wireless section.

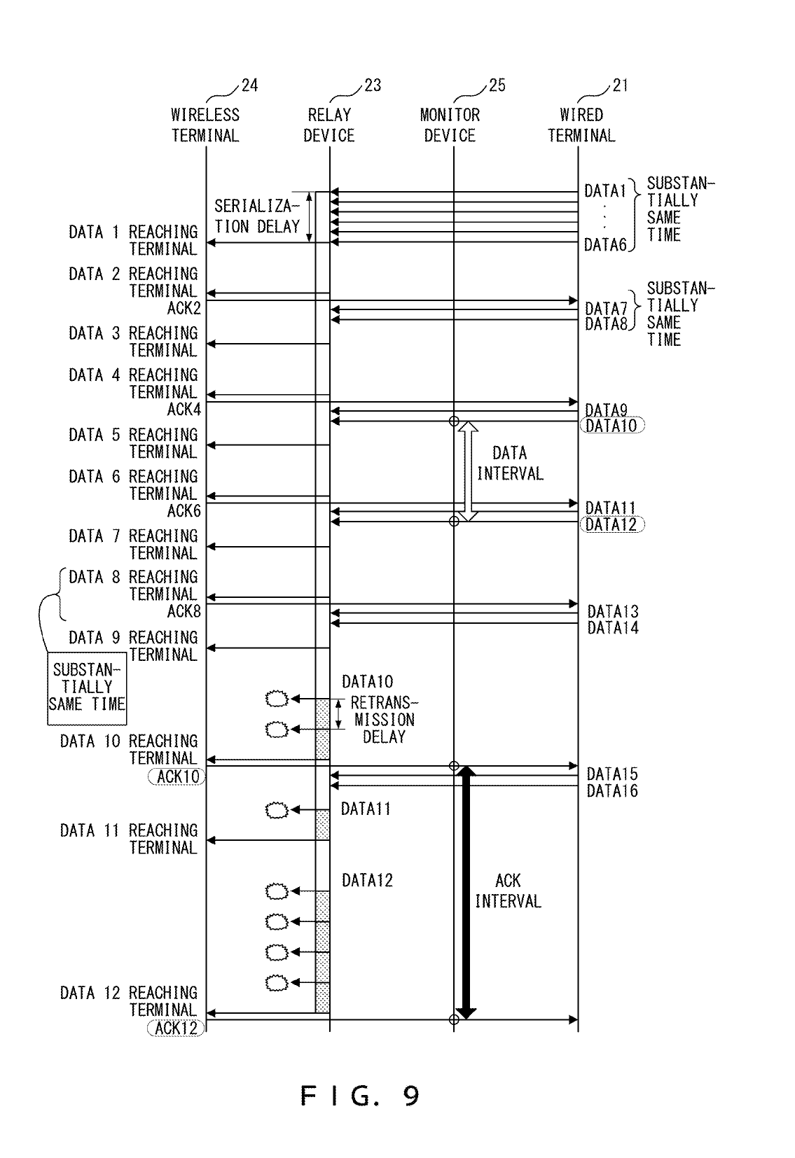

Further described below with reference to an example is the case in which there is no influence of a serialization delay. FIG. 9 is an example of a flow of a packet from the wired terminal 21 to the wireless terminal 24 when there is no influence of a serialization delay. In the example in FIG. 9, one ACK packet corresponds to two data packets, but the present invention is not limited to the example, but an ACK packet may be returned each time a specified amount of data is received.

In FIG. 9, the wired terminal 21 first transmits 6 packets, that is, DATA 1 through 6 to the wireless terminal 24 substantially at the same time. Afterwards, the wired terminal 21 transmits two packets to the wireless terminal 24 substantially at the same time each time the wired terminal 21 receives ACK.

In the relay device 23, there occurs a serialization delay to transmit a data packet to the wireless section.

The wireless terminal 24 returns an ACK packet to the wired terminal 21 each time the wireless terminal 24 receives two data packets.

When the monitor device 25 captures a data packet, it associates the reception time of the data packet with the identification information about the data packet, and stores the reception time in a specified storage area. When the monitor device 25 captures an ACK packet, it associates the reception time of the ACK packet with the identification information about the ACK packet, and stores the reception time in a specified storage area. The stored reception times of the data packet and the ACK packet are used in calculating the data interval and the ACK interval.

For convenience of explanation below, it is assumed that the monitor device 25 regards the DATA 10 and 12 and calculates the difference between the ACK interval and the data interval. The data interval of the DATA 10 and 12 is equal to the serialization delay because the DATA 10 is transmitted when the wired terminal 21 receives the ACK 4, the DATA 12 is transmitted when the ACK 6 is received, and the interval between the ACK 4 and the ACK 6 is equal to the interval of the serialization delay.

Since the data intervals of the DATA 12 and 10 are not less than the value of the serialization delay, the data intervals of the DATA 12 and 10 are equal to each other in the wired section and the wireless section. Therefore, the difference between the ACK intervals and the data intervals of the DATA 12 and 10 at the monitor device 25 is equal to the retransmission time (difference between the retransmission time of the DATA 11 and 12 and the retransmission time of the DATA 9 and 10). Therefore, in the example in FIG. 9, when the DATA 10 and 12 are regarded, the serialization delay does not affect the result of an analysis. Accordingly, the monitor device 25 analyzes the value of the difference between the ACK interval and the data interval of the DATA 10 and 12.

As illustrated in FIG. 9, the retransmission is performed five times from the relay device 23 on the DATA 11 and 12 until the data reach the wireless terminal 24. Therefore, the difference between the ACK interval and the data interval of the DATA 10 and 12 is the value of retransmission delay×5. In this case, the retransmission delay refers to the time taken to perform a retransmitting process once on a packet (the time from the transmission of the first packet to the transmission of a retransmission packet) when a loss of packets occurs etc. Therefore, the relay device 23 calculates the value of the difference between the ACK interval and the data interval of the DATA 10 and 12, and compares the calculated value with the product of the value of the retransmission delay for each type of wireless section and N (N is a positive integer), thereby judging the type of wireless section.

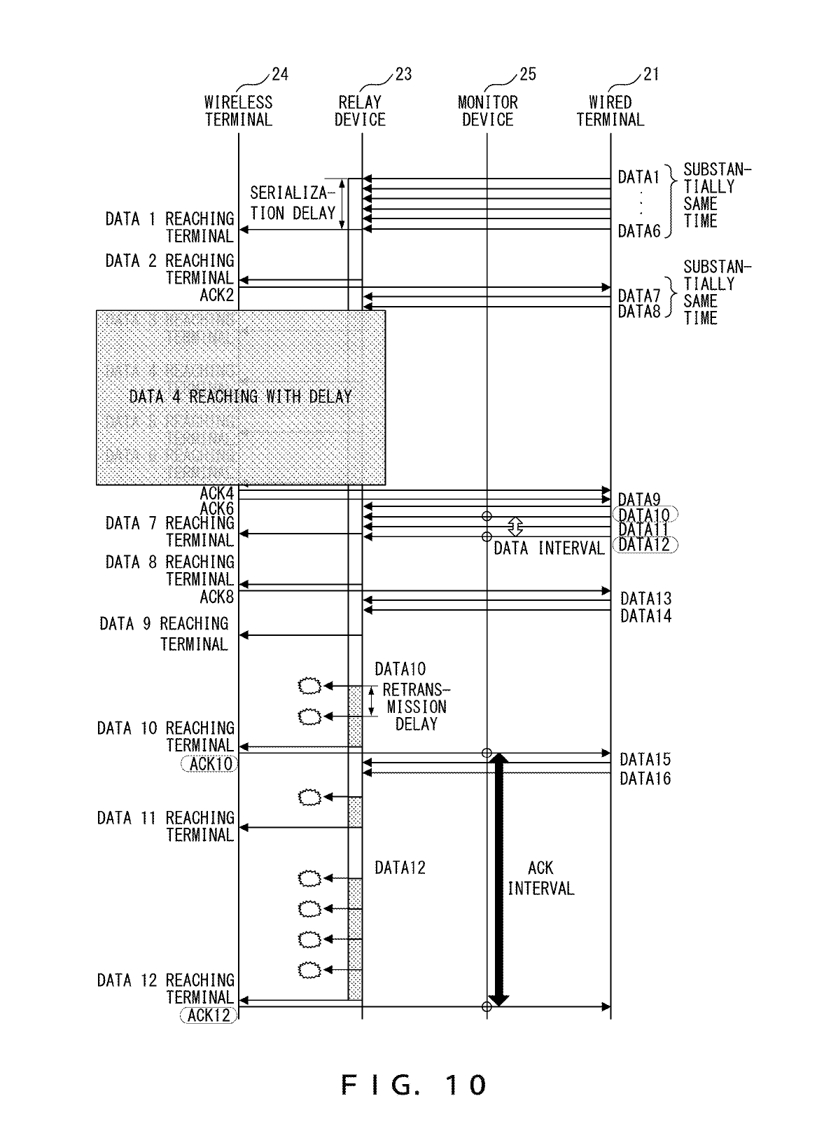

FIG. 10 is an example of a flow of a packet from the wired terminal 21 to the wireless terminal 24 when there is an influence of a serialization delay.

In FIG. 10, the operations of the wired terminal 21, the monitor device 25, the relay device 23, and the wireless terminal 24 are similar to those explained with reference to FIG. 9. However, unlike in FIG. 9, the DATA 4 received with delay in the communication in the wireless section from the relay device 23 to the wireless terminal 24, and the ACK 4 and the ACK 6 are transmitted to the wired terminal 21 substantially at the same time in FIG. 10. In this case, since the wired terminal 21 receives the ACK 4 and the ACK 6 substantially at the same time, the four data packets, that is, the DATA 9 through 12 are transmitted to the wireless terminal 24 substantially at the same time. Then, the data intervals of the DATA 10 and 12 are smaller than the value of the serialization delay.

Then, the data interval in the wireless section of the DATA 10 and 12 is larger than the data interval in the wired section. Therefore, the difference between the ACK interval and the data interval of the DATA 10 and 12 at the monitor device 25 is not equal to the retransmission. Accordingly, in FIG. 10, when the DATA 10 and 12 are regarded, the serialization delay affects the result of an analysis, and the monitor device 25 does not judge the type of wireless section on the value of the difference between the ACK interval and the data interval of the DATA 10 and 12.

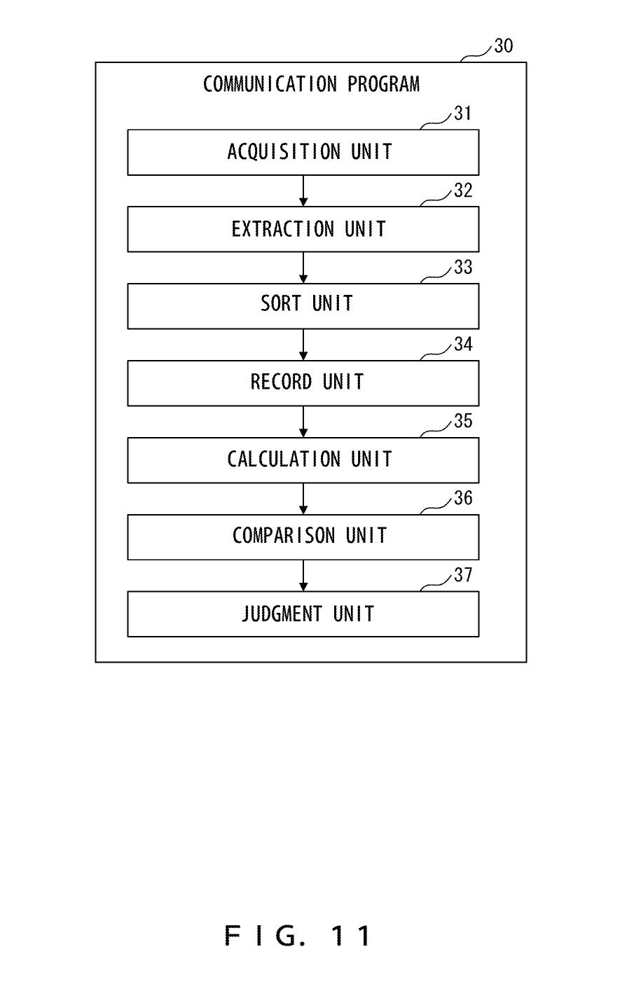

Described next is the configuration of the communication program for performing the wireless section type judging process in the monitor device 25. FIG. 11 is an example of a configuration of the function of a communication program 30 of the monitor device 25. The communication program 30 includes an acquisition unit 31, an extraction unit 32, a sort unit 33, a record unit 34, a calculation unit 35, a comparison unit 36, and a judgment unit 37. The acquisition unit 31 is an example of the reception unit 1. The calculation unit 35 is an example of the calculation unit 2. The comparison unit 36 and the judgment unit 37 are examples of the analysis unit 3.

The acquisition unit 31 receives (captures) a packet. For example, the acquisition unit 31 receives a packet through a network card of the monitor device 25. The network card is connected to the branch device 22 arranged on the wired path, and receives a packet from the branch device 22.

The extraction unit 32 judges whether or not the packet received by the acquisition unit 31 is a TCP, and extracts a TCP packet. Concretely, the extraction unit 32 judges whether or not the captured packet is a TCP packet with reference to the header information about the captured packet, thereby extracting a TCP packet from the received packets.

Described below is the configuration of a packet header.

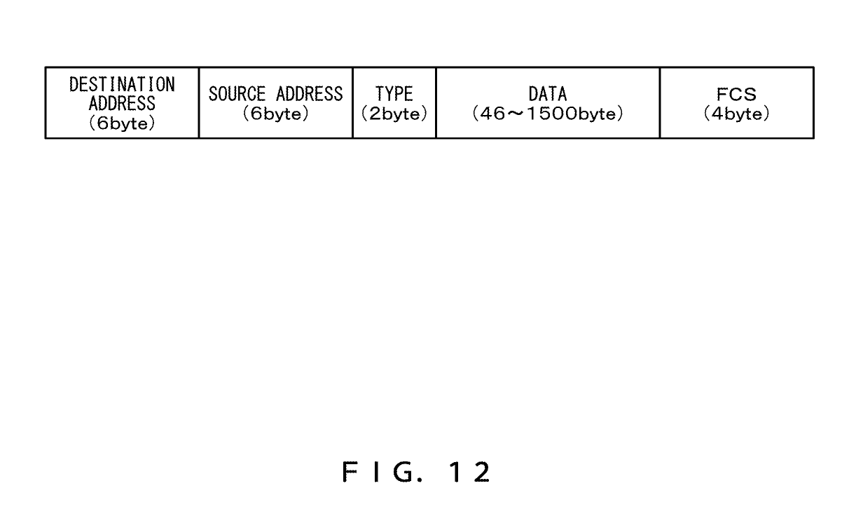

FIG. 12 is an example of a configuration of the header of an Ethernet frame. As illustrated in FIG. 12, the header of an Ethernet frame includes the fields of a destination address, a source address, a type, data, and an FCS (frame check sequence).

The destination address field stores the MAC address of the destination of the frame. The source address field stores the MAC address of the source of the frame. The type field stores the identification information indicating the upper layer protocol stored in the data field. The data field stores data. The FCS field stores the information for detection of an error in the frame.

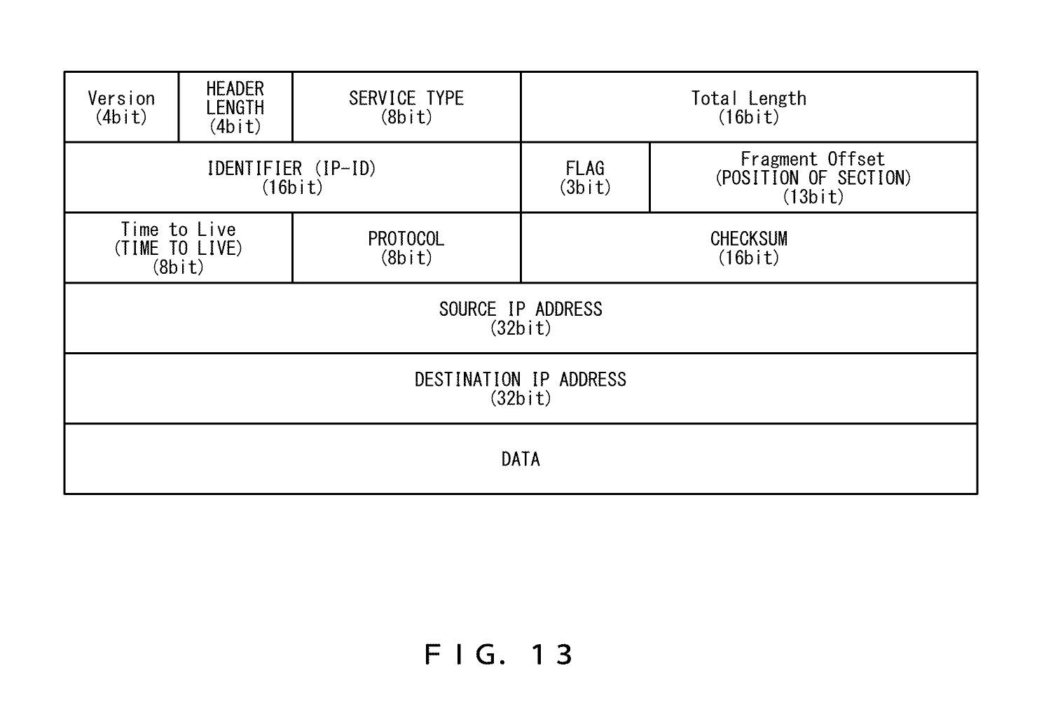

FIG. 13 is an example of a configuration of an IP header. As illustrated in FIG. 13, the IP header includes the fields of a protocol, a source IP address, a destination IP address, and various other pieces of information.

The protocol field stores numbers indicating the type of network protocol in an upper transport layer. For example, the number “1” stored in the protocol field indicates an ICMP (Internet control message protocol), the number “6” indicates a TCP (transmission control protocol), etc. The source IP address field stores the source IP address. The destination IP address field stores the destination IP address.

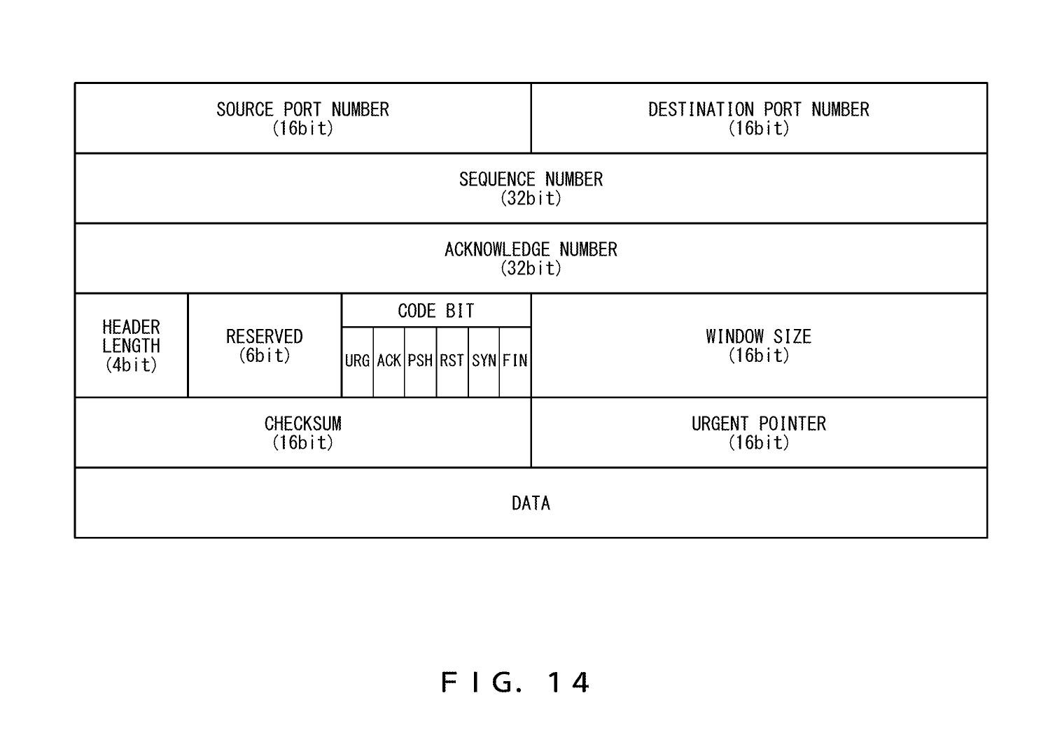

FIG. 14 is an example of a configuration of a TCP header. As illustrated in FIG. 14, the TCP header includes fields of a source port number, a destination port number, a sequence number, an acknowledge number, and other various pieces of information.

The source port number field stores a number for identification of an application of the source. The destination port number field stores the number for identification of an application of the destination. The sequence number field stores a number for sequencing the data to be transmitted. The sequence number also indicates the position of the data to be communicated. The acknowledge number field stores the information about the result of the reception of the received data.

The extraction unit 32 judges the type field of the header of the Ethernet frame of a packet as IPv4 if the field is 0800, and judge the protocol field of the IP header as a TCP if the field is 6.

Although the packet to be extracted is defined as a TCP packet, the present invention is not limited to the application, but various packets may be used so far as an analysis equivalent to the TCP may be performed with the packet in accordance with the protocol for acknowledgement.

The sort unit 33 sorts the packet judged as a TCP for each connection. The connection in the present embodiment is uniquely identified by a combination of the source IP address, the destination IP address, the source port number, and the destination port number of a packet. The sort unit 33 acquires the source IP address and the destination IP address from the source IP address field and the destination IP address field of the IP header. The sort unit 33 acquires the source port number and the destination port number from the source port number field and the destination port number field of the TCP header. The data packet and the ACK packet corresponding to the data packet have interchanged values of source IP addresses (port number) and destination IP addresses (port number), but it is assumed that they are sorted to the same connection.

The record unit 34 stores the reception time of a packet in a specified storage area in association with the identification information about the packet. In the following explanation, the information recorded by the record unit 34 is described as reception history information. The record unit 34 also records in the reception history information the information about an ACK packet in association with a corresponding data packet. The record unit 34 may further store in the reception history information the size of a packet with the reception time of the received packet. The record unit 34 may also record only the information about a particular connection as the reception history information.

The identification information about a packet is the information for uniquely identifying a packet. For example, it is expressed by a combination of a sequence number and an acknowledge number included in the TCP header of a packet and the connection sorted by the sort unit 33.

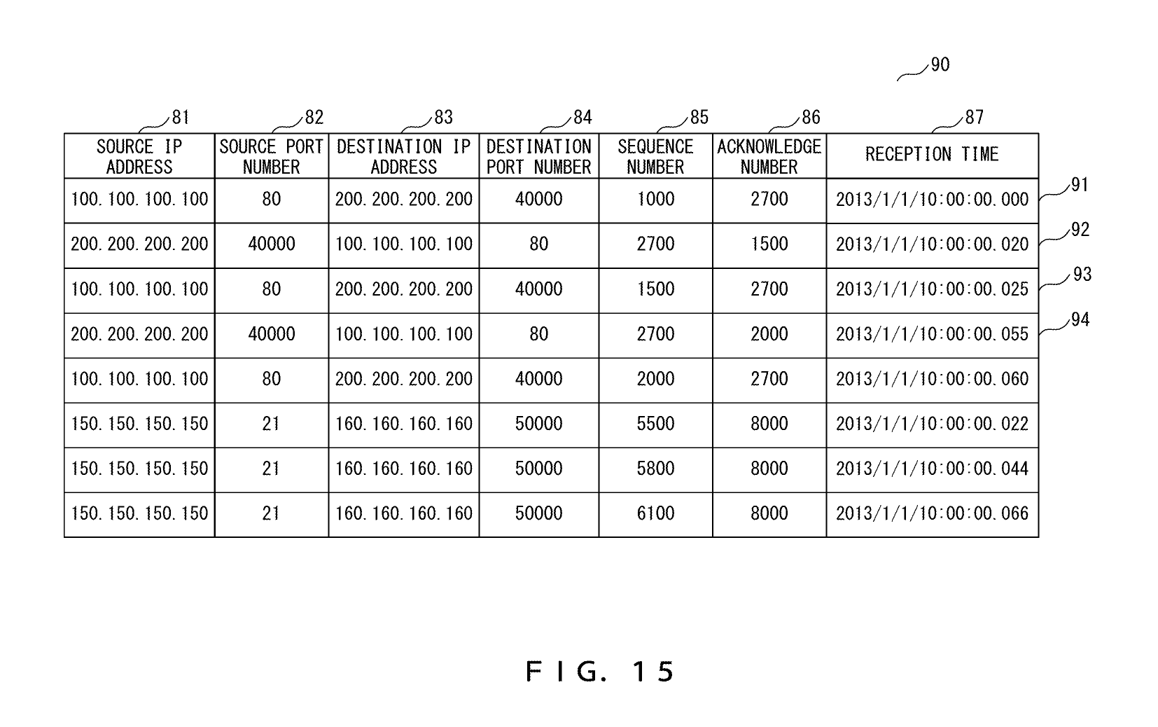

FIG. 15 is an example of the reception history information recorded by the record unit 34. A reception history information 90 includes data items of a source IP address 81, a source port number 82, a destination IP address 83, a destination port number 84, a sequence number 85, an acknowledge number 86, and a reception time 87.

The source IP address 81, the source port number 82, the destination IP address 83, and the destination port number are the information for unique identification of a connection sorted by the sort unit 33.

The sequence number 85 stores the sequence number included in the TCP header of a packet.

The acknowledge number 86 stores the acknowledge number included in the TCP header of a packet.

The reception time 87 stores the time at which the monitor device 25 receives a packet.

The record unit 34 stores the information about the source IP address field and the destination IP address field of the IP header of the received packet in the source IP address 81 and the destination IP address 83 respectively. The record unit 34 further stores the information about the source port number field and the destination port number field of the TCP header of the received packet in the source port number 82 and the destination port number 84 respectively. In addition, the record unit 34 stores the information about each field of the sequence number and the acknowledge number of the TCP header of the received packet in the sequence number 85 and the acknowledge number 86 respectively. Then, the record unit 34 stores the reception time of the received packet in the reception time 87. The record unit 34 stores the reception time of the packet using a timer (clock) of the monitor device 25.

The reception history information 90 in FIG. 15 stores a record 91 having the source IP address 81 of 100.100.100.100, the source port number 82 of 80. the destination IP address 83 of 200.200.200.200., and the destination port number 84 of 40000. The record 91 further includes the sequence number 85 of 1000, the acknowledge number 86 of 2700, the reception time 87 of 2013/1/1/10:00:00.000. For convenience of simple explanation below, four sets each having the source IP address 81 of 100.100.100.100., the source port number 82 of 80, the destination IP address 83 of 200.200.200.200., and the destination port number 84 of 40000 are collectively referred to as a connection A. A set having interchanged values of the source IP address (port number) and the destination IP address (port number) is also referred to as the same connection A.

The reception history information 90 in FIG. 15 further stores a record 92 having the connection of A, the sequence number 85 of 2700, the acknowledge number 86 of 1500, the reception time 87 of 2013/1/1/10:00:00.020. The reception history information 90 also stores a record 93 having the connection of A, the sequence number 85 of 1500, the acknowledge number 86 of 2700, and the reception time 87 of 2013/1/1/10:00:00.025. The reception history information 90 further stores a record 94 having the connection of A, the sequence number 85 of 2700, the acknowledge number 86 of 2000, and the reception time 87 of 2013/1/1/10:00:00.055.

For example, the records 91 and 92 have interchanged values of the source IP address (port number) and the destination IP address (port number), which indicates that the packets are transmitted in the reverse directions in the same connection.

Furthermore, for example, since the sequence number 85 of the record 91 is 1000, and the acknowledge number 86 of the record 92 is 1500, the size of the TCP data of the packet corresponding to the record 91 is 500 (byte). The size of the frame may be calculated by adding the size of the header to the size of the TCP data.

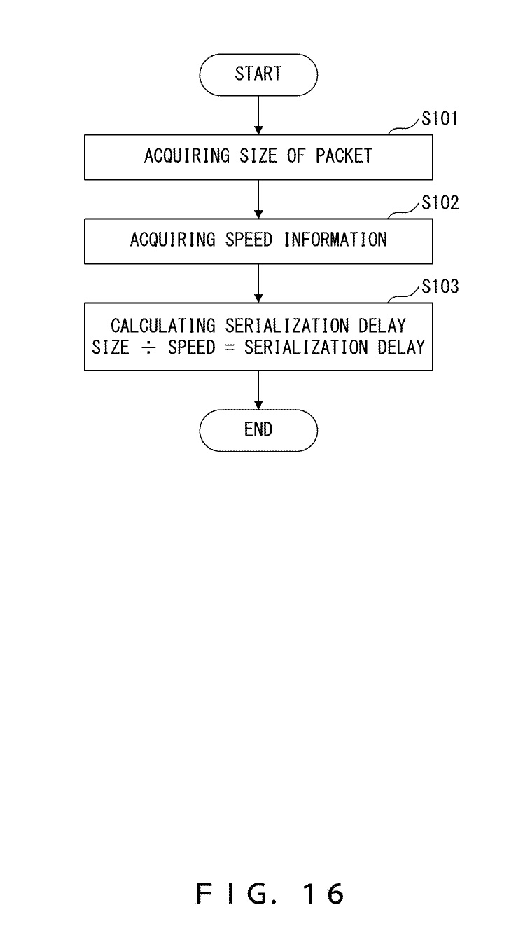

The calculation unit 35 calculates (estimates) the value of the serialization delay which occurs on a specified data packet in the relay device 23. FIG. 16 is a flowchart of the process as an example of a method of calculating a serialization delay.

In the flowchart illustrated in FIG. 16, the calculation unit 35 first acquires the size of a target data packet (S101).

The size of a data packet may be a specified fixed value stored in advance in a specified storage area, or an average value of a specified number of packets received by the relay device 23. In addition, for example, the size of a data packet may be calculated as follows.

That is, the calculation unit 35 first regards specified two ACK packets. The regarded ACK packet maybe an ACK packet received latest by the acquisition unit 31, and any ACK packet. In this example, for convenience of explanation, it is assumed that the two ACK packets to be regarded are ACK packets A and B, and the ACK packet A has been received by the relay device 23 immediately before the ACK packet B in the same connection. The data packets corresponding to the ACK packets A and B are defined as data packets A and B respectively. Then, the calculation unit 35 calculates the average value of the sizes of the data packets received by the relay device 23 in the period between just after the reception of the data packet A and just after the reception of the data packet B.

The calculation unit 35 refer to the reception history information and acquires the size of each data packet. For example, the calculation unit 35 calculates the size based on the difference in the acknowledge number 86 of the records corresponding to the ACK packets A and B included in the reception history information 90.

Next, the calculation unit 35 acquires the transmission rate information (bandwidth) about a wireless section (S102). The transmission rate information is stored in advance in a specified storage area of the monitor device 25.

The calculation unit 35 divides the size of the data packet calculated in S101 by the transmission rate of the wireless section acquired in S102, and calculates the quotient as a serialization delay (S103).

The value of the serialization delay may be a value obtained by adding a specified value to the value calculated in S103 with taking an error between the value calculated in S103 and the actual serialization delay taken into account. For example, with the speed of 1 Mbps and the data size of 1500 bytes, the serialization delay of 12 ms is calculated. A specified value α maybe added to the calculated value, and the serialization delay for two packets may be 12 ms×2 (packets)+α(α=6 ms)=30 ms.

The comparison unit 36 judges whether or not the data interval is not less than the value of the serialization delay.

Concretely, the comparison unit 36 first regards the two specified ACK packets A and B in the ACK packets received by the wireless terminal 24. The packets regarded by the comparison unit 36 may be, for example, the two packets regarded when the calculation unit 35 calculates the size of the data packet. Then, the comparison unit 36 calculates the data intervals of the data packets A and B corresponding to the ACK packets A and B respectively using the reception history information recorded by the record unit 34.

Concretely when the data interval is calculated using the reception history information 90, the comparison unit 36 first specifies the record of the reception history information 90 corresponding to the data packets A and B respectively corresponding to the ACK packets A and B, and acquires the value of the specified record at the reception time 87.

In the example in FIG. 15, it is assumed that the ACK packet A corresponds to the record 92, and the ACK packet B corresponds to the record 94. The comparison unit 36 specifies the record of the reception history information 90 corresponding to the ACK packets A and B based on the connection, the sequence number, and the acknowledge number. Then, from the relationship between the sequence number 85 and the acknowledge number 86, the comparison unit 36 specifies that the data packet corresponding to the ACK packet A is a packet indicated by the record 91. Then, the comparison unit 36 acquires the reception time of the data packet A from the reception time 87 of the record 91. Similarly, the comparison unit 36 specifies that the data packet B corresponding to the ACK packet B is a packet indicated by the record 93, and acquires the reception time of the data packet B from the reception time 87 of the record 93. That is, the comparison unit 36 acquires 2013/1/1/10:00:00.000 and 2013/1/1/10:00:00.025 as the reception time of the data packets A and B corresponding to the ACK packets A and B.

Then, the comparison unit 36 obtains the difference between the two extracted reception times, and calculates the value of the data interval of the data packets A and B. Then, the comparison unit 36 judges whether or not the data interval of the calculated data packets A and B is not less than the value of the serialization delay between the data packets A and B.

In the example in FIG. 15, the comparison unit 36 calculates the data interval between the data packets A and B as 0.025 (s) (2013/1/1/10:00:00.025−2013/1/1/10:00:00.000). Then, the comparison unit 36 judges whether or not 0.025 (s) is not less than the value of the serialization delay calculated by the calculation unit 35.

The judgment unit 37 judges whether or not the subtraction of the data interval from the ACK interval gives a value larger than 0 when the comparison unit 36 judges that the data interval is not less than the value of the serialization delay. That is, the value of the subtraction of the data interval from the ACK interval refers to the delay which has occurred between the monitor device 25 and the wireless terminal 24. If it is judged that the subtraction of the data interval from the ACK interval gives the value larger than 0, then the judgment unit 37 judges whether or not the value obtained by the subtraction of the data interval from the ACK interval matches the wireless retransmission period.

The judgment unit 37 first performs the subtraction of the data interval from the ACK interval. Concretely, the judgment unit 37 regards the ACK packets A and B regarded by the comparison unit 36, and acquires from the reception history information the reception times of the ACK packets A and B at the monitor device 25. In the example of the reception history information 90 in FIG. 15, the judgment unit 37 acquires 2013/1/1/10:00:00.020 and 2013/1/1/10:00:00.055 as the values of the reception time 87 of the records 92 and 94 indicating the reception times of the ACK packets A and B.

Then, the judgment unit 37 acquires the ACK interval of the ACK packets A and B by subtracting the reception time of the ACK packet A from the reception time of the ACK packet B. In the example in FIG. 15, the data interval of the ACK packets A and B is 0.035 (s) (2013/1/1/10:00:00.055-2013/1/1/10:00:00.020).

When the ACK interval is calculated, the judgment unit 37 judges whether or not the ACK interval corresponding to the ACK packets A and B is larger than the data interval.

In the example in FIG. 15, since the ACK interval is 0.035 (s), and the data interval is 0.025 (s), the judgment unit 37 judges that the ACK interval corresponding to the ACK packets A and B is larger than the data interval.

Next, when it is judged that the ACK interval is larger than the data interval, the judgment unit 37 judges whether or not the value of the subtraction of the data interval from the ACK interval matches the wireless retransmission period. Concretely, the judgment unit 37 judges whether or not the subtraction of the data interval from the ACK interval performed by the comparison unit 36 matches the wireless retransmission period stored in advance.

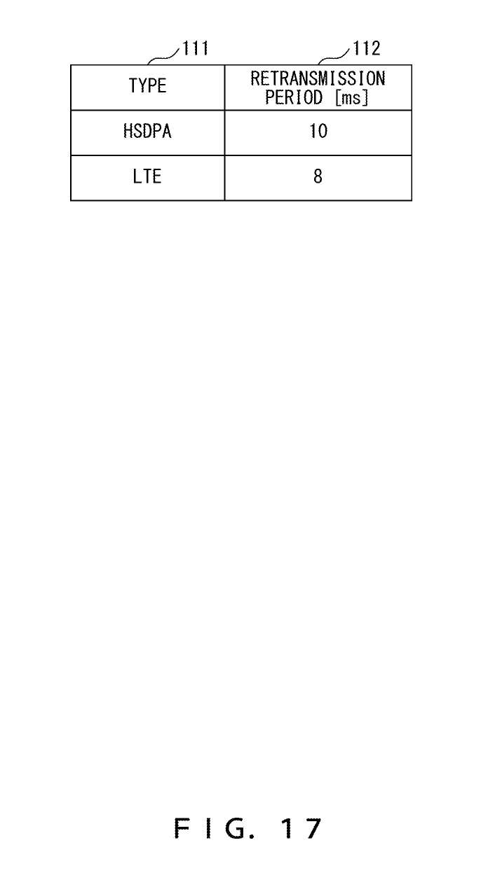

FIG. 17 is an example of the wireless retransmission period information in which the value of the wireless retransmission period is recorded for each type. The wireless retransmission period information includes the data items of a type 111 and a retransmission period 112. The type 111 is identification information for identification of wireless type. The retransmission period 112 is identification information about the retransmission period of wireless type. The retransmission period 112 refers to the retransmission period of wireless type indicated by the type 111. In the example illustrated in FIG. 17, the type 111 indicates HSPDA (high speed downlink packet access) and LTE (long term evolution). 10 ms is described as the retransmission period 112 of the HSPDA, and 8 ms is described as the retransmission period 112 of the LTE. The wireless type 111 may be various types without limiting to the HSPDA and the LTE illustrated in FIG. 17. Furthermore, although FIG. 17 is expressed in the table format, it may be expressed by a data structure so far as the wireless type and the retransmission period may be related.

For example, the judgment unit 37 judges that the value of the subtraction of the data interval from the ACK interval matches the retransmission period of the HSPDA when the value is in the range of 10 ms×N±2 ms (N is a positive integer) (2 ms is an error), and judges that the value does not match the retransmission period when the value is not in the range. In the example illustrated in FIG. 15, the value of the subtraction of the data interval from the ACK interval when the ACK packets A and B are regarded is 0.010 (=0.035−0.025), which is in the range of 10 ms×N±2 ms. Therefore, the judgment unit 37 judges that the value of the subtraction of the data interval from the ACK interval when the ACK packets A and B are regarded matches the wireless retransmission period of the HSPDA.

When the judgment unit 37 judges that the value of the subtraction of the data interval from the ACK interval matches the wireless retransmission period, it judges that the type of wireless section in the connection of the regarded ACK packet is the type of wireless section which has matched the wireless retransmission period. In the case of the example in FIG. 15, since the regarded packets are ACK packets A and B, and the connection is A, the judgment unit 37 judges that the type of wireless section in the connection A is HSPDA.

Otherwise, if the judgment unit 37 accumulates the values of the subtraction of the data interval from the ACK interval when a plurality of packets in the same connection are regarded, and the ratio of the subtraction of the data interval from the ACK interval which matches the retransmission period is not less than a specified threshold, then the judgment unit 37 may judge the type of wireless section. For example, if the ratio of the value that matches the retransmission period of the HSPDA in the values of the subtraction of the data interval from the ACK interval is not less than 80%, then the judgment unit 37 may judge that the type of wireless section is the HSPDA.

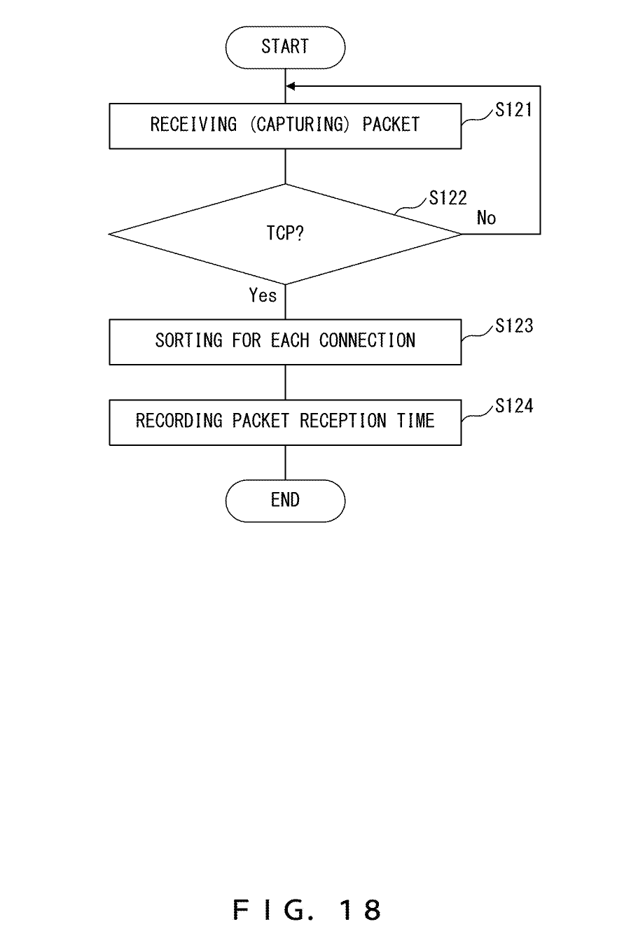

FIG. 18 is a flowchart of the process of the monitor device 25 when the device receives a packet.

In the operation flow in FIG. 18, the acquisition unit 31 receives (captures) a packet (S121). Next, the extraction unit 32 judges whether or not the packet received by the acquisition unit 31 is a TCP (S122). If it is judged that the received packet is not a TCP (NO in S122), then control is returned to S121. On the other hand, in S122, if it is judged that the packet is the TCP (YES in S122), the sort unit 33 sorts the received packet for each connection (S123). Then, the record unit 34 associates the reception time of the packet with the identification information about the packet, and stores it in the reception history information 90 (S124).

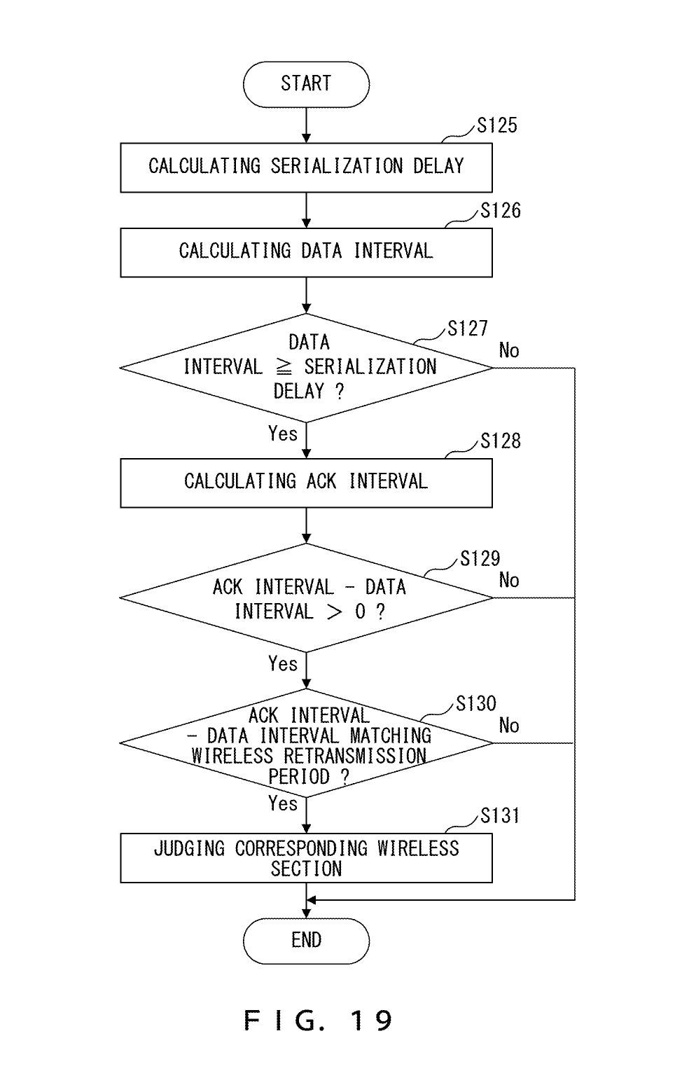

FIG. 19 is a flowchart of the process as an example of the wireless section type judging process by the monitor device 25.

In the operation flow in FIG. 19, the calculation unit 35 first calculates the serialization delay (S125). The concrete flow of calculating the serialization delay has been explained with reference to FIG. 16.

Next, the comparison unit 36 regards a specified ACK packet, and calculates the data interval between two data packets corresponding to the regarded ACK packet and the ACK packet received immediately before the regarded ACK packet (S126). If a specified ACK packet is regarded when the serialization delay is calculated in S125, the comparison unit 36 may regard the same ACK packet as the ACK packet regarded in S125.

Next, the comparison unit 36 judges whether or not the data interval calculated in S126 is not less than the value of the serialization delay calculated in S125 (S127). When the data interval is smaller than the value of the serialization delay (NO in S127), the process is terminated. By suppressing the subsequent wireless section type judging process when the data interval is smaller than the value of the serialization delay, the degradation of the accuracy of wireless section type judgment may be suppressed.

On the other hand, in S127, when the data interval is not less than the value of the serialization delay (YES in S127), the judgment unit 37 calculates the ACK interval between the ACK packet regarded in S126 and the ACK packet received immediately before the ACK packet (S128).

Next, the judgment unit 37 judges whether or not the value obtained by subtracting the data interval calculated in S126 from the ACK interval calculated in S128 is larger than 0 (S129). When the value obtained by the subtraction of the data interval from the ACK interval is not more than 0 (NO in S129), the process is terminated.

On the other hand, when the value obtained by the subtraction of the data interval from the ACK interval is larger than 0 (YES in S129), the judgment unit 37 judges whether or not the value obtained by the subtraction of the data interval from the ACK interval matches the retransmission period (S130). If it is judged that the value obtained by the subtraction of the data interval from the ACK interval does not match the retransmission period (NO in S130), the process is terminated.

On the other hand, when it is judged in S130 that the value obtained by the subtraction of the data interval from the ACK interval matches the retransmission period (YES in S130), the judgment unit 37 judges that the wireless section through which the ACK packet regarded in S126 is transmitted is the wireless section of the type which has matched the retransmission period (S131). Then, the process is terminated.

The flow illustrated in FIG. 19 may be started immediately after the process indicated by the flowchart in FIG. 18. In this case, the ACK packet regarded in S126 may be the ACK packet received by the acquisition unit 31 in S121. The record of the reception history information 90 of the ACK packet immediately before the ACK packet regarded in S126 may be deleted when the process in S128 is terminated. Similarly, the record of the reception history information 90 of the data packet that corresponds to the ACK packet immediately before the ACK packet regarded in S126 maybe deleted when the process in S127 is terminated.

In S129, when the value obtained by the subtraction of the data interval from the ACK interval is calculated, the judgment unit 37 may store the value obtained by the subtraction of the data interval from the ACK interval in a specified storage area in association with the connection of the regarded packet. Then, with reference to the value obtained by the subtraction of the data interval from the ACK interval recorded in the past, the judgment unit 37 may judge the type of the wireless section when the ratio of the value obtained by the subtraction of the data interval from the ACK interval that matches the retransmission period is not less than a specified threshold.

The order of S125 and S126 may be reversed. S128 may be performed before S127. In S126, the data interval of the data packets corresponding to the regarded ACK packet and the ACK packet received immediately before the regarded ACK packet is calculated, but the data interval between any packets may be calculated. In this case, it is assumed that the ACK interval in S128 corresponds to the data interval calculated in S126.

The method for calculating a serialization delay is not limited to the method explained above with reference to FIG. 16, but various methods may be used depending on the communication quality. Described below are other methods of calculating a serialization delay.

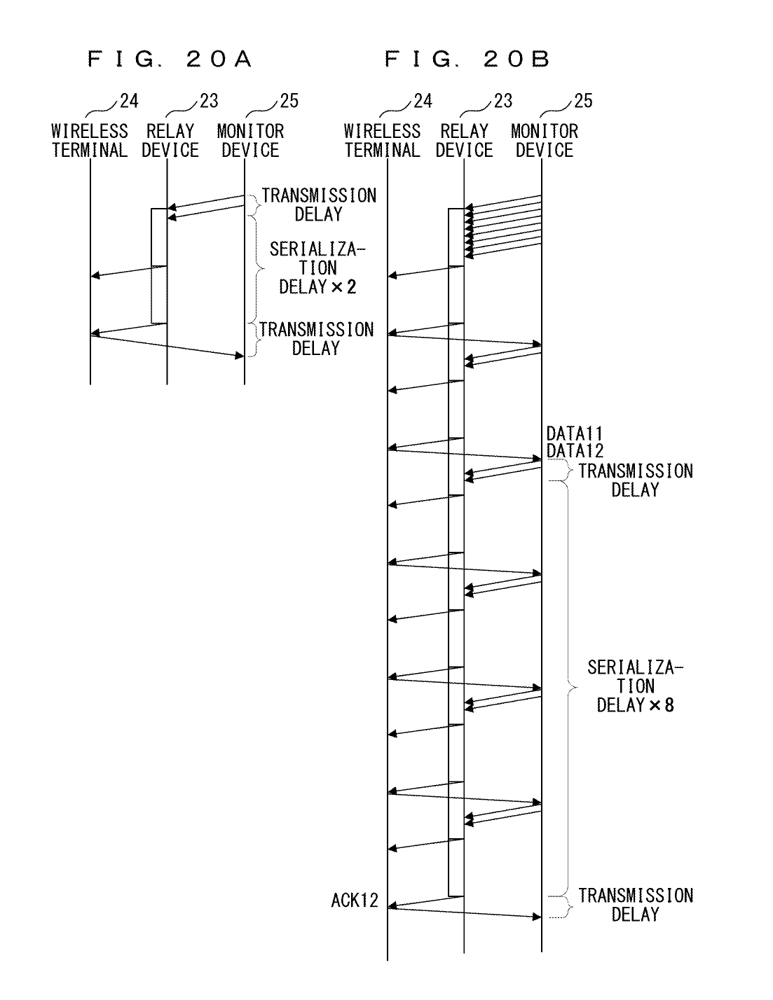

First described is the method of calculating a serialization delay by measuring RTT (round-trip time) when the size of a packet is the same. FIGS. 20A and 20B are explanatory views of the method of calculating a serialization delay by measuring RTT when the size of a packet is the same. In the explanation below with reference to FIGS. 20 through 23, it is assumed that one ACK is returned for two data packets.

FIG. 20A illustrates the data transmitted between the monitor device 25 and the wireless terminal 24 when two packets are newly transmitted if there is no packet for which an ACK is not returned. In this case, when the RTT for two new packets received by the monitor device 25 is measured, RTT (A)=transmission delay+serialization delay×2. The transmission delay is the time required to allow radio waves to reach a device from another device through a transmission section (line).

FIG. 20B illustrates the data transmitted between the monitor device 25 and the wireless terminal 24 when two packets are newly transmitted if the packets to which an ACK is not returned match a window size. The window size refers to the value indicating the amount of data which a transmission side may communicate continuously without an acknowledgment from a reception side. In this case, when the RTT of the two new packets received by the monitor device 25 is measured, RTT (B)=transmission delay+serialization delay×window size. In the case of FIG. 20B, the value of the window size is 8. In FIG. 20B, for example, the RTT of DATA 12 equals transmission delay+serialization delay×8.

When the difference between the RTT (A) in FIG. 20A and the RTT (B) in FIG. 20B is obtained, the transmission delay is offset because the transmission delay is equal between FIG. 20A and FIG. 20B, thereby obtaining RTT (B)−RTT (A)=serialization delay×(window size−2). Therefore, the serialization delay may be calculated by serialization delay=RTT (B)−RTT (A)/(window size−2).

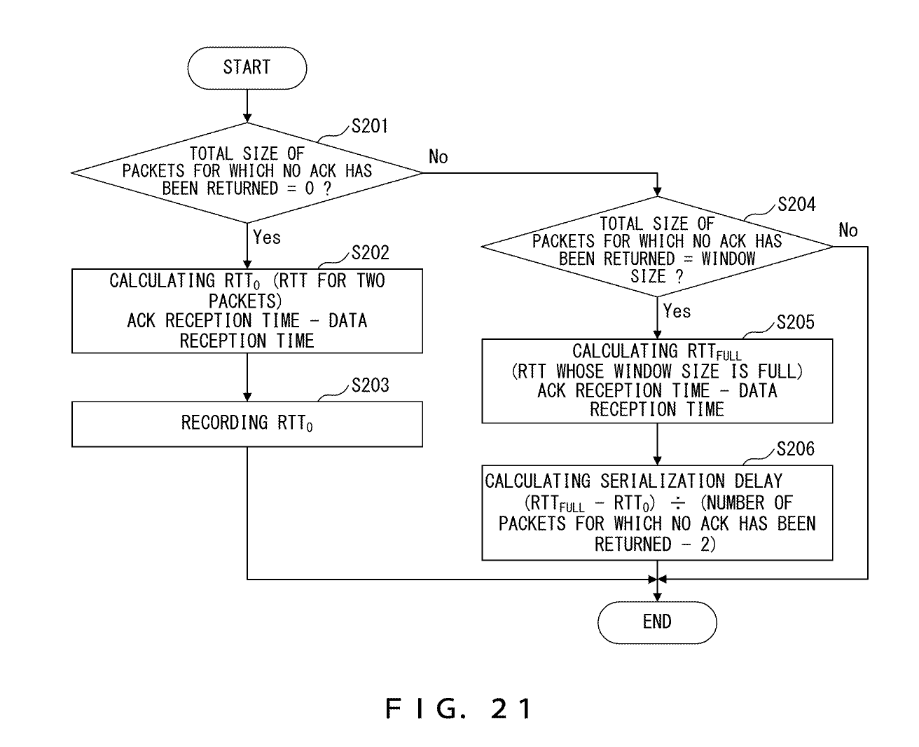

FIG. 21 is a flowchart of the method of calculating a serialization delay by measuring the RTT when the sizes of packets are the same.

In the flow in FIG. 21, the calculation unit 35 of the monitor device 25 first judges whether or not the total size of the packets for which no ACK is returned from the wireless terminal 24 is 0 in the data packets transmitted from the wired terminal (S201). Concretely, the calculation unit 35 refers to the reception history information, specifies a data packet for which no ACK is returned, and judges whether or not a total size of the specified data packets is 0. In the example in FIG. 15, the calculation unit 35 specifies the data packet for which no ACK has been returned by confirming in the reception history information 90 whether or not there is a record of an ACK packet corresponding to the data packet in the data packets received by the monitor device 25. Then, the calculation unit 35 counts the size of the data packets for which no specified ACK has been returned, and judges whether or not the total value is 0.

In S201, when the total size of the packets for which no ACK has been returned is 0 (YES in S201), the calculation unit 35 calculates the RTT₀ as the RTT of the two data packets which are received by the monitor device 25 substantially at the same time (S202). Concretely, the calculation unit 35 calculates the RTT₀ from the reception time of the two data packets received by the monitor device 25 and the reception time of the ACK packet corresponding to the data packets. The RTT₀ for the two data packets equals the transmission delay+(serialization delay×2).

Then, the calculation unit 35 records the RTT₀ calculated in S202 in a specified storage area (S203). Then, the process is terminated.

If the total size of the packets for which no ACK has been returned is not 0 (NO in S201), the calculation unit 35 judges whether or not the total size of the packets for which no ACK has been returned equals the window size (S204). If the total size of the packets for which no ACK has been returned does not equal to the window size (NO in S204), then the process is terminated.

On the other hand, if the total size of the packets for which no ACK has been returned in S204 (NO in S204), then the calculation unit 35 next calculates RTT_{full} as the RTT of the two data packets which the monitor device 25 receives substantially at the same time (S205). Concretely, the calculation unit 35 calculates the RTT_{full} from the reception time of the two data packets received by the monitor device 25 substantially at the same time and the reception time of the ACK packet corresponding to the data packets. The RTT_{full} of the data packets for the window size equals to the transmission delay+(serialization delay×window size).

Next, the calculation unit 35 calculates the serialization delay using the RTT₀ recorded in S203 and the RTT_{full} calculated in S205 (S206). Concretely, the calculation unit 35 calculates the value of (RTT_{full}−RIT₀)/(number of packets for which no ACK has been returned−2) as a serialization delay.

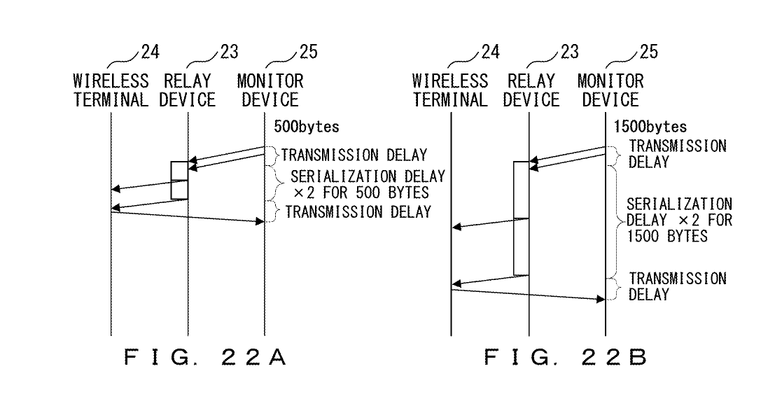

Described next is the method of calculating a serialization delay using packets in different sizes. In this method, by obtaining the difference in RTT between packets having different sizes, the transmission delay is offset, and the serialization delay is calculated. FIGS. 22A and 22B are explanatory views of the method of calculating a serialization delay when the sizes of packets are different. FIG. 22A indicates the transmission of the packet of 500 bytes in size from the monitor device 25 to the wireless terminal 24. FIG. 22B indicates the transmission of the packet of 1500 bytes in size from the monitor device 25 to the wireless terminal 24.

In FIGS. 22A and 22B, since the value of the transmission delay is the same, but the packet size is different. Therefore, there arises a difference in serialization delay. Accordingly, by subtracting the RTT in FIG. 22A from the RTT in FIG. 22B, the value of the transmission delay is offset, and the difference in serialization delay is calculated. By dividing the difference in serialization delay by the difference in size, the value of the serialization delay per unit size may be calculated.

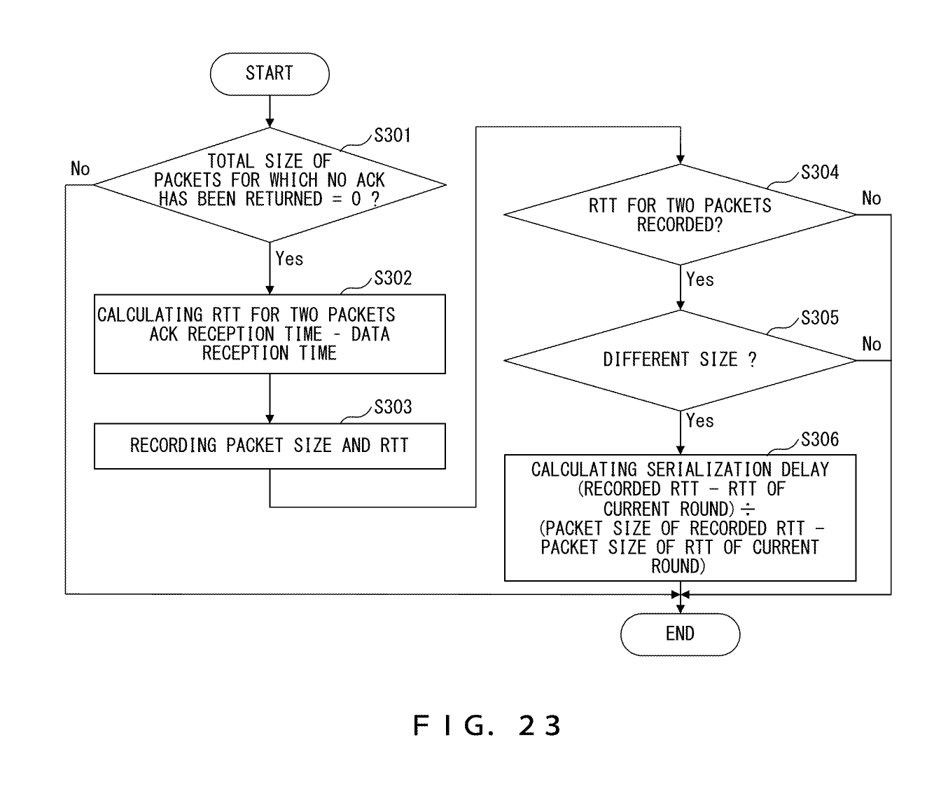

FIG. 23 is a flowchart of the method of calculating a serialization delay when the sizes of packets are not the same.

In the flow in FIG. 23, the calculation unit 35 of the monitor device 25 judges whether or not a total size of the packets for which no ACK has been returned from the wireless terminal 24 is 0 in the data packets transmitted from the wired terminal 21 (S301). Concretely, the calculation unit 35 refers to the reception history information, specifies a data packet for which no ACK has been returned, and judges whether or not a total size of specified data packets is 0. In the example in FIG. 15, by confirming whether or not there is a record of an ACK packet corresponding to a certain data packet in the reception history information 90 in the data packets received by the monitor device 25, the calculation unit 35 specifies the data packet for which no ACK has been returned. Then, the calculation unit 35 sums up the sizes of the data packets for which no specified ACK has been returned, and judges whether or not the total value is 0. If it is judged that the total size of the packets for which no ACK has been returned from the wireless terminal 24 is not 0 (NO in S301), that is, if there is a data packet for which no ACK has been returned, the process is terminated.

If it is judged in S301 that the total size of the packets for which no ACK has been returned from the wireless terminal 24 is 0 (YES in S301), the calculation unit 35 calculates the RTT 1 as the RTT for two data packets (S302). Concretely, the calculation unit 35 obtains the difference between the reception time of the two data packets next received substantially at the same time by the monitor device 25 and the reception time of the acknowledge packet corresponding to the data packets, and calculates the RTT 1. In the case of the example in FIG. 15, the calculation unit 35 acquires the reception time of the ACK packet and the data packet from the reception time 87 of the corresponding record in the reception history information 90.

The RTT refers to the time taken by the monitor device 25 from the transmission of a data packet to the reception of an ACK for the data packet. The RTT between the monitor device 25 and the wireless terminal 24 equals (transmission delay between monitor device 25 and wireless terminal 24×2)+(serialization delay per packet). Therefore, since the RTT 1 is the RTT for two data packets, the RTT 1 equals (transmission delay between monitor device 25 and wireless terminal 24×2)+(serialization delay per packet×2).

Then, the calculation unit 35 records the RTT 1 calculated in S302 in association with the packet size of the two data packets in a specified storage area (S303). The recorded packet size of the two data packets and RTT 1 are referred to as communication information in the description below.

Next, the calculation unit 35 judges whether or not the communication information has been stored in the storage area separately from the communication information recorded in S303 (S304). The communication information recorded in S303 is described as communication information A, and the communication information already stored separately from the communication information recorded in S303 is described as communication information B. If the communication information B is not stored in the storage area (NO in S304), the process is terminated.

If it is judged in S304 that the communication information B has already been stored in the storage area (YES in S304), the calculation unit 35 compares the two packet sizes included in the communication information A and the communication information B, and judges whether or not the two packet sizes are different (S305). If it is judged that the packet sizes of the communication information A and B are equal (NO in S305), the process is terminated.

If it is judged in S304 that the packet sizes in the communication information A and B are different from each other (YES in S305), then the calculation unit 35 calculates the serialization delay by the following equation.

serialization delay per unit size=(RTT 1 of communication information B−RTT 1 of communication information A)/(packet size of communication information B−packet size of communication information A)

The value of the serialization delay of a specified size is calculated by multiplying the value of the serialization delay per unit size by a specified size. Then, the process is terminated.

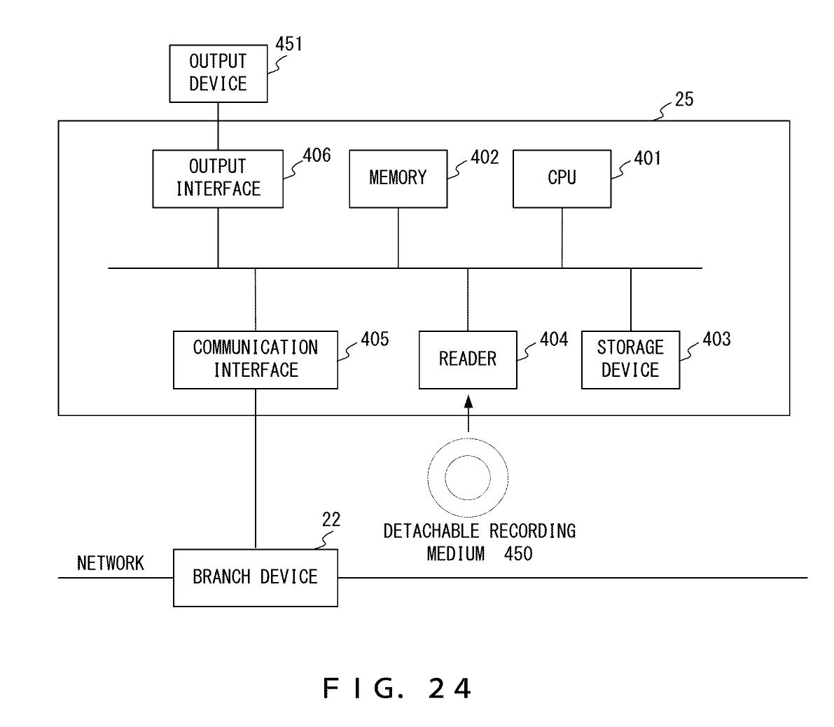

Described next is the configuration of the monitor device 25. FIG. 24 is an example of a configuration of the hardware of the monitor device 25.

The monitor device 25 includes a CPU 401, memory 402, a storage device 403, a reader 404, a communication interface 405, and an output interface 406. The CPU 401, the memory 402, the 403, the reader 404, the communication interface 405, and the output interface 406 are connected through a bus.

The CPU 401 provides all or a part of the functions of the acquisition unit 31, the extraction unit 32, the sort unit 33, the record unit 34, the calculation unit 35, the comparison unit 36, and the judgment unit 37 by executing the program describing the procedure of the flowchart above using the memory 402.

The memory 402 is, for example, semiconductor memory, and is configured by including a RAM area and a ROM area. The storage device 403 is, for example, a hard disk, and stores the communication program 30 according to an embodiment of the present invention. The storage device 403 may be semiconductor memory such as flash memory etc. The storage device 403 may also be an external storage device. The memory 402 or the storage device 403 stores all or a part of the reception history information, the size of a packet, the transmission rate of a wireless section, the wireless retransmission period information, the RTT of a packet, and the communication information. The memory 402 or the storage device 403 is an example of the storage unit 4.

The reader 404 accesses a detachable recording medium 450 at an instruction of the CPU 401. The detachable recording medium 450 maybe realized by a semiconductor device (USB memory etc.), a medium (magnetic disk etc.) to and from which information is input and output by a magnetic effect, a medium (CD-ROM, DVD, etc.) to and from which information is input and output by an optical effect, etc. The reader 404 may be located outside the monitor device 25.

The communication interface 405 is connected to the branch device 22, and communicates data over a network at an instruction from the CPU 401.

The output interface 406 is connected to an output device 451, and the CPU 401 outputs a result of the execution of the communication program 30. The output interface 406 may be located outside the monitor device 25.

The communication program according to an embodiment of the present invention is provided for the monitor device 25 in the following configuration, for example.
(1) Installed in advance in the storage device 403.
(2) Provided by the detachable recording medium 450.
(3) Provided from a program server (not illustrated in the attached drawings) through the communication interface 405.

Furthermore, a part of the monitor device 25 according to an embodiment of the present invention may be realized by hardware. Otherwise, the relay device 23 may be realized by a combination of software and hardware.

The relay device 23 relays a wired section to a wireless section, but the present invention is not limited to this application. That is, the wired section may be various types of high-speed line, and the wireless section may be various types of low-speed line. Furthermore, the delay which occurs in a relay device is a serialization delay as described above, but the present invention is not limited to the serialization delay. That is, so far as a delay may be estimated as with the serialization delay, various delays which occur in a relay device other than the retransmission delay may be used, and combinations of them may be applied.

The present embodiments are not limited to the embodiment described above, but maybe various configurations or embodiments within the scope of the gist of the present invention.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A packet analysis device comprising:
a processor that executes a process including:
receiving packets to be transmitted to a terminal device through a relay device;
calculating a delay time indicating time taken by the relay device from start to completion of the transmission of the packet according to the received packet; and
analyzing communication quality between the relay device and the terminal device when a reception interval of the packets is longer than the delay time.

2. The packet analysis device according to claim 1, wherein
the calculating calculates the delay time taken by the relay device from the start to the completion of the transmission of the packet to a wireless section according to the packet received from a wired section.

3. The packet analysis device according to claim 2, the process further including:
receiving acknowledge packets for the packets, wherein
the calculating calculates the delay time using a difference between a reception interval of a first packet and a second packet and a reception interval of an acknowledge packet for the first packet and an acknowledge packet for the second packet.

4. The packet analysis device according to claim 2, the packet analysis device further comprising:
a storage unit which stores information transmission rate about the wireless section, wherein
the calculating calculates the delay time according to transmission rate information about the wireless section and a size of the packet received from the wired section.

5. A packet analyzing method executed by a packet analysis device, the packet analyzing method comprising:
receiving, by the packet analysis device, packets transmitted to a terminal device through a relay device;
calculating, by the packet analysis device, a delay time indicating time taken by the relay device from start to completion of the transmission of the packet according to the received packet; and
analyzing, by the packet analysis device, communication quality between the relay device and the terminal device when a reception time of the packets is longer than the delay time

6. The packet analyzing method according to claim 5, wherein
the calculating calculates the delay time taken by the relay device from the start to the completion of the transmission of the packet to a wireless section according to the packet received from a wired section.

7. The packet analyzing method according to claim 6, the packet analyzing method further comprising:
receiving acknowledge packets for the packets, wherein
the calculation calculates the delay time using a difference between a reception interval of a first packet and a second packet and a reception interval of an acknowledge packet for the first packet and an acknowledge packet for the second packet.

8. The packet analyzing method according to claim 6, wherein
the calculation calculates the delay time according to the transmission rate information stored in a storage unit which stores transmission rate information about the wireless section and a size of the packet received from the wired section.

9. A non-transitory computer-readable recording medium having stored therein a program for causing a computer to execute a process, the process comprising:
receiving packets transmitted to a terminal device through a relay device;
calculating a delay time indicating time taken by the relay device from start to completion of the transmission of the packet according to the received packet; and
analyzing communication quality between the relay device and the terminal device when a reception time of the packets is longer than the delay time

10. The non-transitory computer-readable recording medium according to claim 9, wherein
the calculating calculates the delay time taken by the relay device from the start to the completion of the transmission of the packet to a wireless section according to the packet received from a wired section.

11. The non-transitory computer-readable recording medium according to claim 10, the process further comprising:
receiving acknowledge packets for the packets, wherein
the calculating calculates the delay time using a difference between a reception interval of a first packet and a second packet and a reception interval of an acknowledge packet for the first packet and an acknowledge packet for the second packet.

12. The non-transitory computer-readable recording medium according to claim 10, wherein
the calculating calculates the delay time according to the transmission rate information stored in a storage unit which stores transmission rate information about the wireless section and a size of the packet received from the wired section.
